(19) United States
(12) Patent Application Publication
(10) Pub. No.: US 2006/0106603 A1
(43) Pub. Date: May 18, 2006

(54) Method and apparatus to improve speaker intelligibility in competitive talking conditions

(75) Inventors: Marc Andre Boillot, Plantation, FL (US); Pratik V. Desai, Boca Raton, FL (US); Zaffer S. Merchant, Parkland, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 10/989,618

(22) Filed: Nov. 16, 2004

(51) Int. Cl. G10L 15/08

(52) U.S. Cl. 704/238

(57) ABSTRACT

A system, wireless device (102) and method improve speaker intelligibility in a multi-party call by receiving a plurality of individual voice signals, determining a pitch contour for each individual voice signal, determining that the pitch contours for at least two of the individual voice signals are within a predetermined range relative to each other, and shifting the pitch of at least one voice signal a predetermined amount for the duration of the call. The pitch of the individual voice is shifted one to approximately five semitones. The method is performed at a central control station (110) prior to summation of the signals, or at an individual receiving unit (204) when three or more wireless devices (102) are communicating without the use of a central control station (110).

### BACKGROUND OF THE INVENTION

1. Field of the Invention

The present invention generally relates to the field of wireless communications, and more particularly relates to a method to improve speaker intelligibility on multi-party calls, in competitive talking conditions.

2. Background of the Invention

Conference calls, or phone conversations involving more than two parties, have become commonplace in today's business environments. Often times it is necessary or convenient for meetings or discussions to occur remotely, with several participants located at various places. However, it is a well-known phenomenon that when several people are speaking at the same time, a listener often has difficulty in distinguishing an individual voice. This is known as the “cocktail party effect.” This problem is particularly enhanced when the conversation occurs over a phone because the listener does not have the added visual stimulus of actually seeing the speaker. It is not uncommon for conference calls to routinely involve people that have never even met, therefore it may be particularly cumbersome to attempt to place the voice heard over the phone with a face.

The task of listening to only one individual in a group of people talking is called speaker tracking. One attribute that is well associated with speaker tracking is pitch. Pitch is the frequency of the vocal chord vibrations and is characteristic of a specific individual's speaking voice. It has been experimentally determined that the difficulty in distinguishing between speakers in a group increases when the speakers have a common pitch range, such as a group of male speakers or a group of female speakers. In a typical conference call, it is not uncommon for two or more of the parties to have similar voice pitches, thereby increasing the difficulty in distinguishing between speakers.

Therefore, a need exists to overcome the problems with the prior art, as discussed above.

### SUMMARY OF THE INVENTION

Briefly, in accordance with preferred embodiments of the present invention, disclosed are a system, method, wireless device, and computer readable medium for improving speaker intelligibility in a multi-party call by receiving a plurality of individual voice signals, determining a pitch contour for each individual voice signal, determining that the pitch contours for at least two of the individual voice signals are within a predetermined range relative to each other (usually within one semitone), and shifting the pitch of at least one voice signal a predetermined amount for the duration of the call. The pitch of the individual voice is shifted one to approximately five semitones.

The method is performed at a central control station prior to summation of the signals, or at an individual receiving unit when three or more wireless devices are communicating without the use of a central control station. Additionally, when the method is performed at a central control station, the individual voice signals and any shifted voice signals will be combined into a single composite signal, then encoded and transmitted to individual communication devices.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a system diagram illustrating a communications system incorporating improved speaker intelligibility under competitive talking conditions, according to an embodiment of the present invention.

FIG. 2 is a more detailed block diagram illustrating a mobile communication device of the system of FIG. 1, according to an embodiment of the present invention.

FIG. 3 is a more detailed block diagram illustrating a transmitting unit and receiving unit of a mobile communication device of the system of FIG. 1, according to an embodiment of the present invention.

FIG. 4 is a pitch shifter block diagram, in accordance with in an embodiment of the present invention.

FIG. 5 is a block diagram illustrating sequencing and cross fading for pitch shifting, in accordance with an embodiment of the present invention

FIG. 6 is an operational flow diagram illustrating portions of an exemplary pitch shifting process for improving speaker intelligibility, according to an embodiment of the present invention.

FIG. 7 is a diagram illustrating an example of a voice signal in accordance with an embodiment of the present invention.

FIG. 8 is a diagram illustrating a pitch estimate and a pitch contour for the voice signal of FIG. 7 in accordance with an embodiment of the present invention.

FIG. 9 is a diagram illustrating how a pitch period can be determined by autocorrelation analysis, in accordance with an embodiment of the present invention.

FIG. 10 illustrates another portion of flow diagram of FIG. 6, illustrating portions of an exemplary pitch shifting process for improving speaker intelligibility in accordance with an embodiment of the present invention.

FIG. 11 is a more detailed block diagram illustrating a central control station of the system of FIG. 1, according to another embodiment of the present invention.

FIG. 12 is an operational flow diagram illustrating portion of an exemplary pitch sifting process for improving speaker intelligibility at a central control station of FIGS. 10 and 11 in accordance with another embodiment of the present invention.

### DETAILED DESCRIPTION OF THE EMBODIMENT

Terminology Overview

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an,” as used herein, are defined as “one or more than one.” The term “plurality,” as used herein, is defined as “two or more than two.” The term “another,” as used herein, is defined as “at least a second or more.” The terms “including” and/or “having,” as used herein, are defined as “comprising” (i.e., open language). The term “coupled,” as used herein, is defined as “connected, although not necessarily directly, and not necessarily mechanically.” The terms “program,” “software application,” and the like as used herein, are defined as “a sequence of instructions designed for execution on a computer system.” A program, computer program, or software application typically includes a subroutine, a function, a procedure, an object method, an object implementation, an executable application, an applet, a servlet, a source code, an object code, a shared library/dynamic load library and/or other sequence of instructions designed for execution on a computer system.

Overview

The present invention, according to one embodiment, advantageously overcomes problems with the prior art by shifting the fundamental frequency of a speaker's voice (or speakers' voices) when the pitch of two or more of the parties in a multi-party call have voices with fundamental frequencies that lie within a predetermined range relative to the other voices.

Digital mobile communication devices, such as cellular phones or two-way radios, transmit and receive encoded voice data. In other words, when a user speaks into the wireless device, the user's voice is digitized and transformed into a format that is more suitable for transmission. This encoding process is normally performed by sending the voice signal through a vocoder, an audio processor that captures an audio signal, digitizes it, and encodes the digital information according to certain characteristic elements such as the fundamental frequency and associated noise components. This process compresses the amount of data to be transmitted, thereby requiring less bandwidth than traditional analog systems. By advantageously using the voice data associated with the vocoder, the present invention improves the speaker's voice intelligibility by shifting the fundamental frequency of one or more similar voices for the duration of a multi-party call.

Communication System

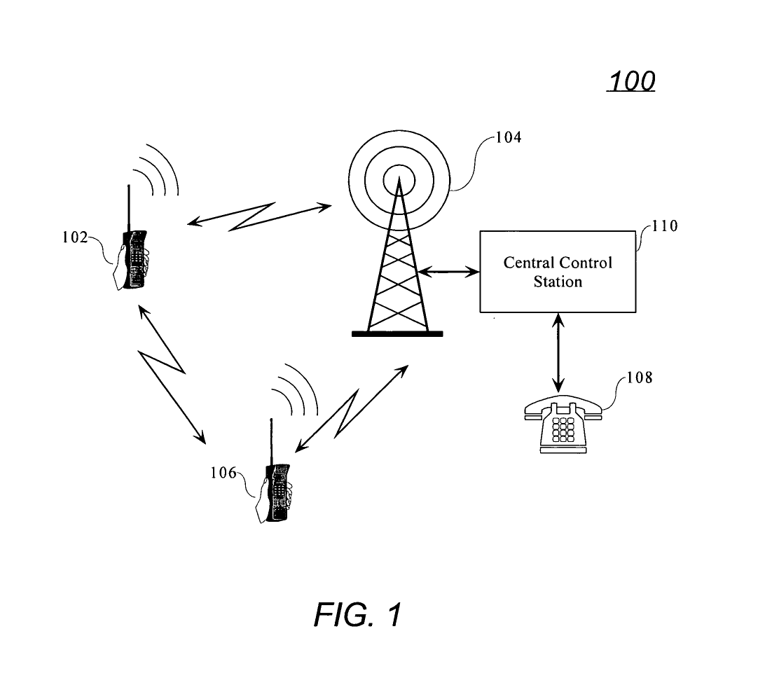

Referring to FIG. 1, a preferred embodiment of the present invention consists of at least one wireless mobile subscriber device (or wireless device) 102, operating within range of a cellular base station 104. In order to participate in multi-party calls, there must be at least three callers, communicating either by another wireless device 106 or a wired telephone 108 that communicates with the cellular base station 104 through a central control station 110. Alternately, the wireless devices 102, 106 operates in a mode in which each wireless device 102, 106 communicates directly with each other and a third similar wireless device (not shown) (i.e. it is unnecessary to process the call through the cellular base station 104).

Wireless Device

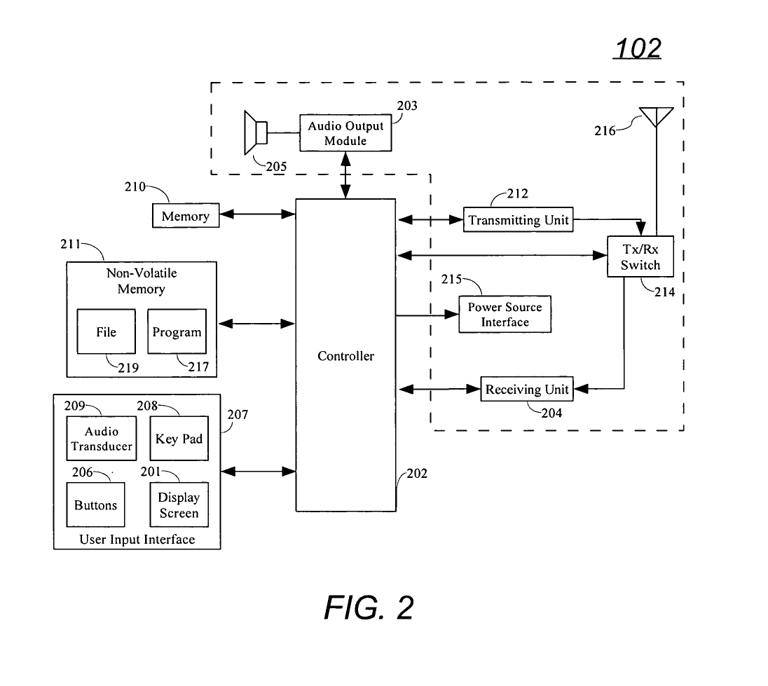

A block diagram of an exemplary wireless device 102 is shown in FIG. 2. An exemplary wireless device 102 includes a controller 202, communicatively coupled with a user input interface 207. The user input interface 207 includes, in this example, buttons 206 that are part of a keypad 208, and an audio transducer 209 such as in a microphone (not shown) to receive and convert audio signals to electronic audio signals for processing in the wireless device 102 in a manner well known to those of ordinary skill in the art. The wireless device 102, according to the present example, also comprises a memory 210, a non-volatile (program) memory 211 containing at least one application program 217 and a file 219, and a power source interface 215.

The controller 202 is communicatively coupled to the user input interface 207 for receiving user input from a user of the wireless device 102. It is important to note that the user input interface 207, in one exemplary embodiment, typically comprises a display screen 201 with touch-screen features or “soft buttons” as also known in the art. The controller 202 is also communicatively coupled to the display screen 201 (such as a display screen of a liquid crystal display module) for displaying information to the user of the device 102. The display screen 201 may therefore serve both as a user input device (to receive user input from a user) and as a user output device to display information to the user. The user input interface 207 couples data signals to the controller 202 based on the keys 208 or buttons 206 pressed by the user. The controller 202 is responsive to the user input data signals thereby causing functions and features under control of the controller 202 to operate in the wireless device 102.

The wireless device 102, according to one embodiment, comprises a wireless communication device 102, such as a cellular phone, a portable radio, a PDA equipped with a wireless modem, or other such type of wireless device. The wireless communication device 102 transmits and receives signals for enabling a wireless communication such as for a cellular telephone, in a manner well known to those of ordinary skill in the art.

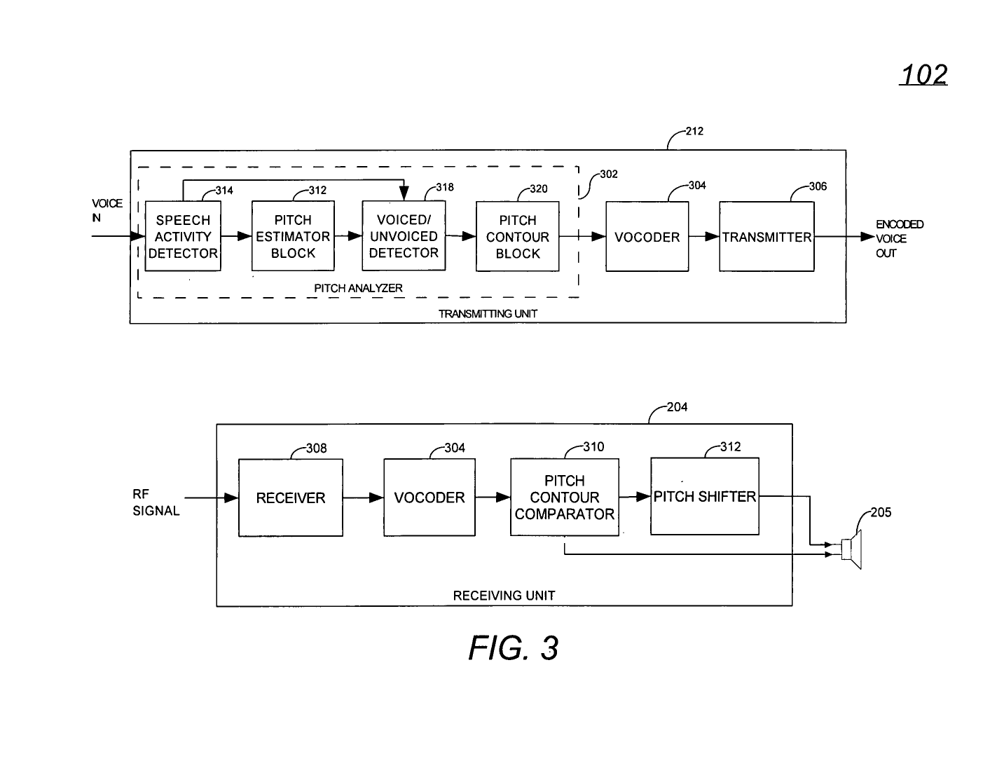

For example, in a “transmit” mode, the controller 202, responding to a detection of a user input (such as a user pressing a button or switch on the keypad 208), controls the audio circuits and couples electronic audio signals from the audio transducer 209 of a microphone interface to a transmitting unit 212 which is shown in more detail in FIG. 3. The controller 202 controls the transmitting unit 212 and a radio frequency (RF) transmit/receive switch 214 to turn ON the transmitter function of the wireless device 102. In one embodiment, the transmitting unit 212 includes a pitch analyzer 302, a vocoder 304 for encoding the audio signals, and a transmitter 306. The pitch analyzer 302 is coupled to the vocoder 304, which is coupled to the transmitter 306.

Pitch Analyzer in Transmitter of Wireless Device

Briefly, the pitch analyzer 302 monitors the pitch of a voice signal in the transmitting unit 212. In one embodiment, the pitch analyzer 302 includes a speech activity detector 314 that receives a voice signal, a pitch estimating block 316, a voiced/unvoiced detector 318, and a pitch contour block 320. The voice signal is divided into a plurality of time-based frames. The speech activity detector 314 is coupled to the pitch estimating block 316 and detects speech activity on the incoming voice signal. The pitch estimating block 316 is coupled to the voiced/unvoiced detector 318. The pitch estimating block 316 estimates the pitch of the voice signal for at least a portion of the time-based frames of the voice signal.

Pitch Shifting

The teachings of Pitch Shifting is taught in U.S. patent application Ser. No. 10/900,736, entitled “Method and System for Improving Voice Quality of A Vocoder”, filed on Jul. 28, 2004, which is assigned to the same assignee as this application and the collective teachings are hereby incorporated by reference.

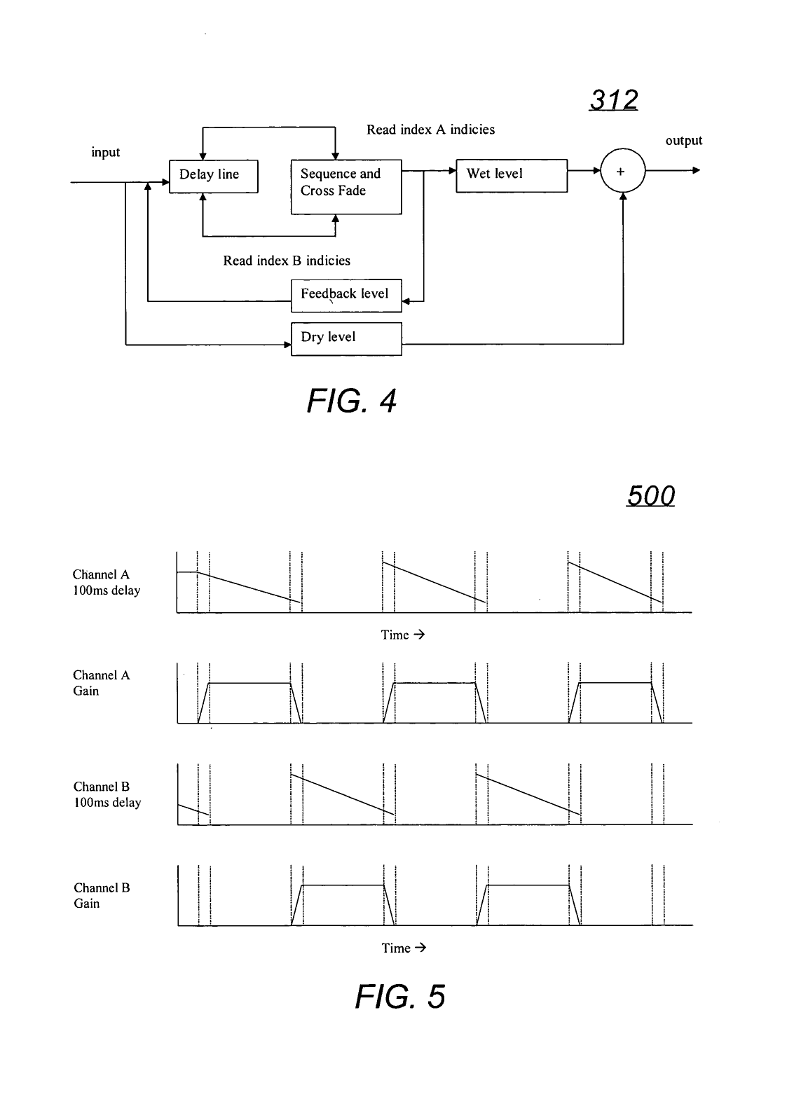

Various methods of pitch shifting are possible. The simplest of which is to change the sampling rate. By changing the sampling rate one effectively changes the time and frequency information of the resultant speech signal. FIG. 4 is a pitch shifter block diagram which has been shown to be used advantageously in an embodiment of the present invention. More sophisticated methods such as time or frequency decomposition methods allow for non-integer sampling rate changes which provide a smoother pitch interpolation between speech frame boundaries and doing so without adjusting the time scale. A pitch shifting device changes the fundamental frequency of voice without changing the time representation. In effect it sounds like the person is talking with a higher or lower pitch though the prosody (or tempo) of the speech does not change, i.e. they have the same speaking rate. Females for example have higher pitch whereas males have lower pitch, and this is because the average frequency of vibration of the vocal chords for males is lower due to their physical properties.

FIG. 5 is a block diagram illustrating sequencing and cross fading for pitch shifting, in accordance with an embodiment of the present invention. Pitch shifting devices can adjust the pitch in incremental steps or in continuous increments, the latter of which being more difficult and requiring more sophisticated signal processing techniques. Albeit, a simple method of pitch shifting using the Doppler effect also used in the Lent Technique of pitch shifting is presented for illustration. The Doppler effect is the effect heard when a stationary observer hears a sound source that is either moving towards them or away from them. If the sound source is moving towards the observer the frequency of the sound is heard to increase, i.e. the pitch increases. If the sound source is moving away the frequency of the sound source is heard to decrease, i.e., the pitch decreases. A pitch shifter incorporates the Doppler effect by introducing signal delay. The rate at which delay changes over time controls how much pitch shift is generated.

To raise the pitch of a voice signal, a delay is inserted in the signal path and ramped from 100 ms towards zero as seen in FIG. 5. The length of the delay is decreased at each sample time by an amount proportional to the frequency rise desired. To lower the pitch, the signal is ramped from 0 delay to 100 ms delay. The signals are essentially mixed with their time delayed versions. One problem is that at some point, the delay cannot be changed Hence the delay must be restarted, but done so without causing noticeable artifacts. Hence the signals must be faded in and out relative to one another to properly mix the signals with the right delay. This cross fading is staggered over time and set to minimize discontinuities and to provide a smooth transition between signals. This technique of time domain pitch shifting is a synchronized series of operations which allows for smooth upward and downward pitch shifting. Other pitch shifting techniques are also known in literature to provide smoother pitch interpolation and on a continuous pitch scale.

Referring again to FIG. 3, the voiced/unvoiced detector 318 is coupled to the pitch contour block 320 and in one embodiment has a signaling path to the pitch contour block 320. The speech activity detector 314 includes a signaling path to the voiced/unvoiced detector 318. In one embodiment, the voiced/unvoiced detector 318 detects voiced and unvoiced portions of speech that are on the voice signal, and the pitch contour block 320, based on the pitch estimation, determines a pitch contour for the voice signal.

The vocoder 304 encodes the voice signal such as by generating frames. The encoded voice signal and the pitch information obtained by the pitch analyzer 302 is transmitted by the transmitter 306 by modulating these electronic audio signals onto an RF signal and coupling the modulated signal to the antenna 216 through the RF TX/RX switch 214 for transmission in a wireless communication system (not shown). This transmit operation enables the user of the device 102 to transmit, for example, audio communication into the wireless communication system in a manner well known to those of ordinary skill in the art.

Receiver of Wireless Device

When the wireless communication device 102 is in a “receive” mode, the controller 202 controls the radio frequency (RF) transmit/receive switch 214 that couples an RF signal from an antenna 216 through the RF transmit/receive (TX/RX) switch 214 to a receiving unit 204, in a manner well known to those of ordinary skill in the art. At the receiving unit 204, a receiver 308 receives, converts, and demodulates the RF signal, then a decoding section 304 decodes the information contained in the demodulated RF signal and provides a baseband signal to an audio output module 203, which includes a vocoder 304, a pitch contour comparator 310, a pitch shifter 312, and a transducer 205, such as a speaker, for outputting received audio. Those of skill in the art will appreciate, however, that the transmitting unit 110 and the receiving unit 112 include other suitable components for performing many other functions.

In this way, for example, received audio is provided to a user of the wireless device 102. A receive operational sequence is normally under control of the controller 202 operating in accordance with computer instructions stored in the program memory 211, in a manner well known to those of ordinary skill in the art. The controller 202 operates the transmitting unit 212, the receiving unit 204, the RF TX/RX switch 214, and the associated audio circuits 203 according to computer instructions stored in the program memory 211.

Software and Computer Program Medium

In this document, the terms “computer program medium,” “computer-usable medium,” “machine-readable medium” and “computer-readable medium” are used to generally refer to media such as memory 210 and non-volatile program memory 211, removable storage drive, a hard disk installed in hard disk drive, and signals. These computer program products are means for providing software to the mobile subscriber unit 102. The computer-readable medium allows the wireless device 102 to read data, instructions, messages or message packets, and other computer-readable information from the computer-readable medium. The computer-readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer-readable medium may comprise computer-readable information in a transitory state medium such as a network link and/or a network interface, including a wired network or a wireless network, that allow a computer to read such computer-readable information.

Various software embodiments are described in terms of this exemplary system. After reading this description, it will become apparent to a person of ordinary skill in the relevant art(s) how to implement the invention using other computer systems and/or computer architectures.

Semitone Shifting

According to Peter F. Assmann, of the University of Texas at Dallas, in the article “Fundamental Frequency and the Intelligibility of Competing Voices,” studies have found that it is easier to understand two people speaking at the same time when the voices differ in fundamental frequency (F₀). When the pitch of a voice is increased by one octave its F₀ doubles. The frequency range between octaves is divided into twelve semitones. Sentence intelligibility (percentage of words identified correctly) improves as the difference in F₀ between the voices increases from zero to three semitones, but decreases when ΔF₀ is twelve semitones (one octave). The improved intelligibility may be contributed to a combination of improved perceptual segregation and overcoming the perceptual tendency for simultaneous sounds to blend into one when they have identical pitches.

An embodiment of the present invention uses the encoded voice data received at the receiving unit 204 to overcome the difficulty with perceiving an individual voice during a multi-party call when more than one speaker, having voices with similar pitches, are talking simultaneously. Information concerning the pitch of each speaker's voice is extracted and altered to slightly shift the pitch of a speaker's voice. This slight shift allows the user of the wireless device 102 to more readily identify the party that is speaking.

Pitch Monitoring Flow

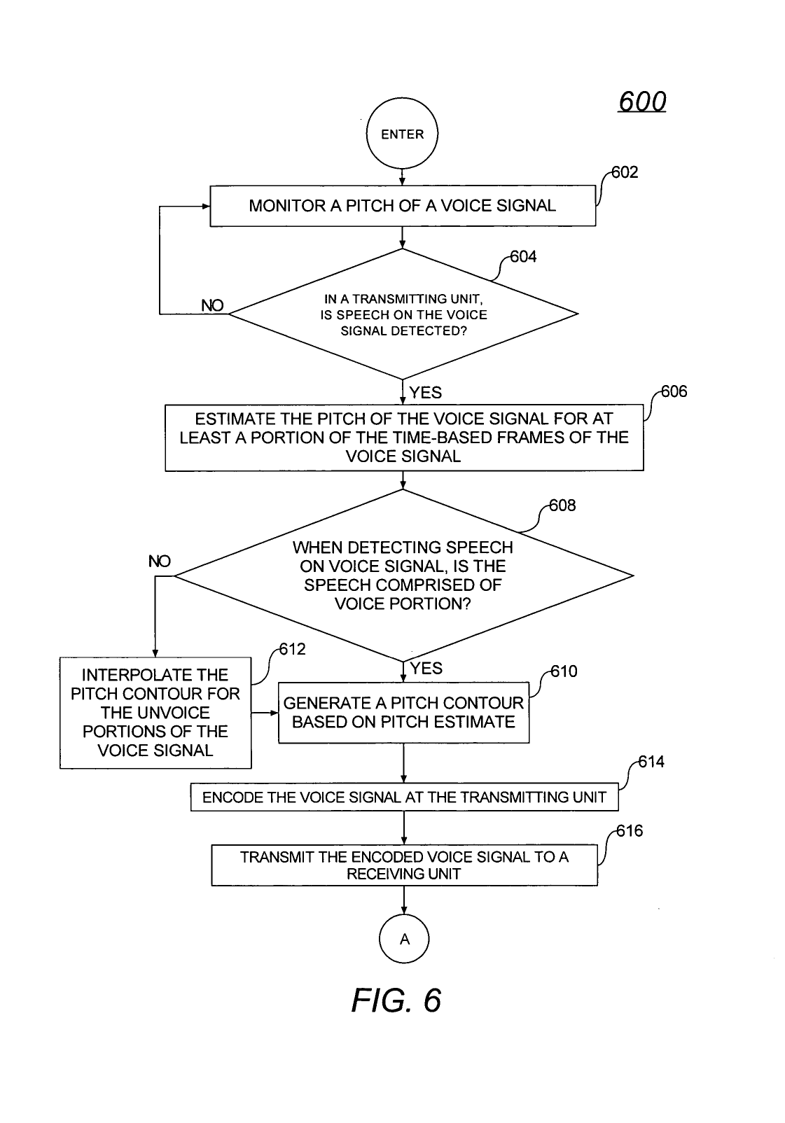

Referring to FIG. 6, shown is an operational flow diagram illustrating portions of an exemplary pitch shifting process for improving speaker intelligibility, according to an embodiment of the present invention. When describing the method 600, reference will be made to FIGS. 2 and 3, although it must be noted that the method 600 can be practiced in any other suitable system or device such as central control system 110 which is described in a separate example later. Moreover, the steps of the method 600 are not limited to the particular order in which they are presented in FIG. 6. The inventive method can also have a greater number of steps or a fewer number of steps than those shown in FIG. 6. In one particular example, the vocoder 304 that will be described in reference to this example can have a minimum encoding pitch frequency of 80 Hz and a maximum encoding pitch frequency of 500 Hz. Moreover, an exemplary operating ceiling for the vocoder 304 can be 750 Hz. It must be noted, however, that the invention is not limited to these particular values.

In one embodiment, all users communicate directly with each other without the use of a central control station 110. Because there is no central control station 110, each receiving unit 204 has direct access to and identifies the voice signal transmitted from another wireless device 102. When the parties involved in the call communicate through a central control station 110, the individual voice signals are combined into a single signal before being transmitted to the receiving unit 204. In that scenario, because the receiving unit 204 is unable to distinguish between incoming voices, the method described in this invention is performed at the central control station 110 prior to transmission and will be discussed further later.

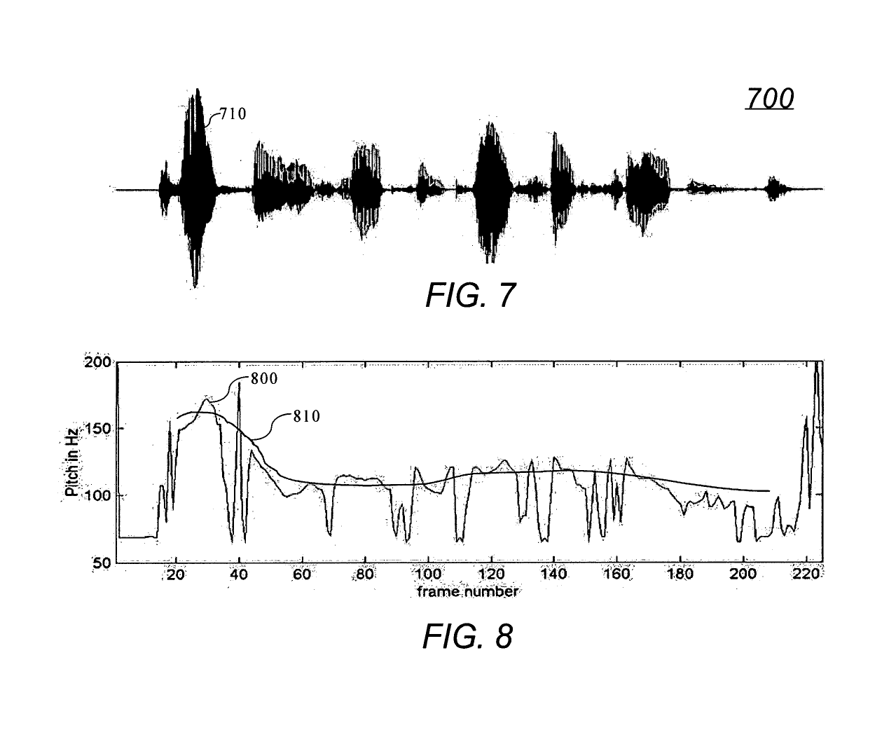

At step 602, the method 600 begins by monitoring the pitch of a voice signal. One way to monitor the pitch of the voice signal is shown in steps 602-612. For example, at decision block 604, in a transmitting unit 212, the method determines whether speech is present on the voice signal 710 (FIG. 7). If speech is not present, then the method 600 resumes at step 602. If speech is present, at step 606, the pitch of the voice signal is estimated for at least a portion of the time-based frames of which the voice signal is comprised. At decision block 608, the method determines whether the speech on the voice signal is comprised of a voice portion. If the speech is a voice portion, a pitch contour is generated for the voice signal based on the pitch estimating step 606, as shown at step 610. If unvoiced portions are present in the speech, then a pitch contour for the unvoiced portions of the voice signal is generated by interpolation, as shown at step 612.

Referring to FIG. 3, the pitch analyzer 302 monitors the pitch of a voice signal. Specifically, the speech activity detector 314 in the transmitting unit 212 detects speech on the voice signal. The term speech includes any spoken words whether they are generated by a living being or a machine. When speech is detected, the speech activity detector 314 signals the voiced/unvoiced detector 318. An example of detected speech 710 of a voice signal 700 is illustrated in FIG. 7.

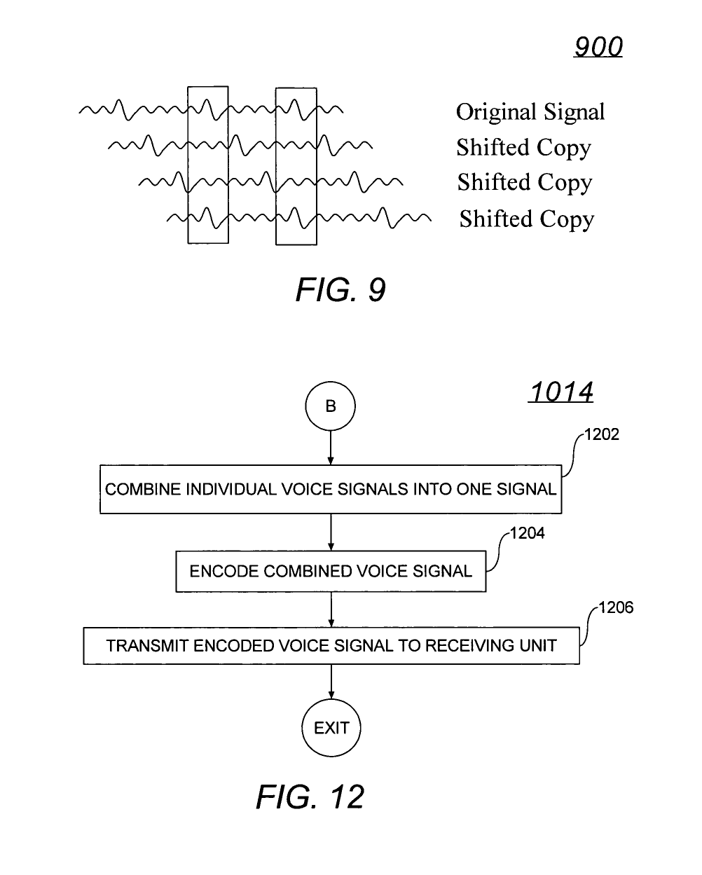

The pitch estimating block 316 (see FIG. 3) estimates the pitch of the voice signal 700 for at least a portion of time-based frames of the voice signal 700. For example, the voice signal 700 is divisible into a plurality of time-based frames. As is known in the art, because a person's vocal cords vibrate with a certain fundamental frequency, the resulting waveform is characterized as a periodic signal. As a result, for at least a portion of these frames, the pitch estimating block 316 estimates the periodicity of the voice signal 300. Referring to FIG. 9, a time-based frame vs. pitch graph showing a pitch estimate (or pitch track) 900 for the detected speech 710 of FIG. 7 is shown

The pitch estimating block 316 uses various methods to estimate the periodicity of the voice signal 700 for the frames, including both time and frequency analyses. As an example of a time analysis, the pitch estimating block 316 employs an autocorrelation analysis, also known as the maximum likelihood method, for pitch estimation. As is known in the art, autocorrelation analysis reveals the degree to which a signal is correlated with itself, which reveals the fundamental pitch period. Alternatively, the pitch estimating block 316 assesses the zero crossing rate of the voice signal. This well-known principle in one embodiment is used to determine the periodicity, as the fundamental frequency is periodic and cycles around an origin level. If a frequency analysis is desired, the pitch estimating block 316 relies on techniques like harmonic product spectrum or multi-rate filtering, both of which use the harmonic frequency components of the voice signal 600 to determine the fundamental pitch frequency.

Referring to FIGS. 3, 7 and 9, following pitch estimation, the voiced/unvoiced detector 318 determines which parts of the detected speech 710 are voice portions and which parts are unvoiced portions. For purposes of the invention, the voice portion of the voice signal 700 is that part of the voice signal 700 that includes a periodic component of the voice signal 700. This phenomena is generally produced when vowels are spoken. In contrast, the unvoiced portion of the voice signal 700 is that part of the voice signal 700 that includes non-periodic components. The unvoiced portion of the voice signal 700 is typically produced when consonants are spoken. The voiced/unvoiced detector 318 detects the voice and unvoiced portions of the detected speech 710 of the voice signal 700 and signals the pitch contour block 320. To detect the voiced and unvoiced portions, the voiced/unvoiced detector 318 uses any of a number of well-known algorithms.

Average Pitch Tracking Algorithms

Speech is composed of periodic and non-periodic sections which are commonly referred to as voiced and unvoiced, respectively. The voiced sections are described as voiced due to their voiced nature, i.e., these sections are quasi-periodic pulses of air generated by the lungs and passed through the vocal chords to make acoustic pressure waves which are periodic in nature due to the vocal chord vibrations. Voiced speech is generally higher in energy than voiced speech as a result air being forcefully exhaled by the lungs through the smaller vocal fold openings. Unvoiced speech is less energetic with less vocalization due to reduced use of the vocal chords and lungs. Standard voice activity detectors (VAD) employ knowledge of speech production when making a voiced versus an unvoiced speech decision. Autocorrelation based algorithms such as the Maximum Likelihood Method identifies the level of periodicity in a speech signal. An autocorrelation technique describes how well a signal is correlated with itself. A highly periodic signal tends to exhibit high correlative properties. Autocorrelation techniques are generally employed in the time domain though similar approaches can be used in the frequency domain. A Spectral Flatness Measure (SFM) reveals the degree of periodicity in a speech signal by evaluating the harmonic structure of speech in the frequency domain and is used to identify voiced and unvoiced speech. Sub-band processing and filter-bank methods can be used to identify the level of harmonic structure in the formant regions of speech as voiced/unvoiced methods. Unvoiced speech is more spectrally flat compared to voiced speech which usually is highly periodic and has a −6 dB/octave high frequency roll-off. Energy level detectors which determine the amplitude of the waveform or the spectral energy are commonly used to differentiate between voiced and unvoiced speech. Common integration circuits or sample and hold circuits can be used to assess energy level. A VAD typically employs a combination of a periodicity detector and a energy level detector to make a voiced or unvoiced decision.

Pitch Estimation

Pitch detection is an important component for various speech processing systems. The pitch reveals the nature of the excitation source in models of speech production and describes the fundamental frequency of the vocal chord vibrations. An analysis of the pitch over time is known as the pitch contour, an example of which is illustrated in FIG. 8. The pitch contour 810 essentially tracks the pitch information 800 as time progresses. The pitch contour 810 is useful information for speaker recognition and speaker identification tasks. The pitch contour 810 is also well known and required for all speech analysis-synthesis vocoder systems. Pitch estimation involves the estimation of the periodicity of a signal. Because the vocal chords vibrate with a certain fundamental frequency the resulting waveform is characterized as a periodic signal. The estimation of periodicity in a signal is done through various methods. The most common illustration for pitch estimation is that of autocorrelation analysis. Autocorrelation analysis reveals the degree to which a signal is correlated with itself and hence reveals the fundamental pitch period. Turning to FIG. 9, shown is a diagram illustrating how a pitch period can be determined by autocorrelation analysis.

First a copy of the speech signal is created. This copy serves as a template upon which a correlation analysis is performed. This copy is shifted over time and correlated with the original. Correlation analysis involves a point by point multiplication of all the signal samples between the original and the copy. One would expect to achieve the maximum correlation value when the signal being shifted matches the original signal. When the copy is shifted to a point which also corresponds to the fundamental pitch period the resulting correlation is strongest. This point reveals the pitch period and hence the pitch.

The autocorrelation analysis used for pitch detection is also known as the maximum likelihood method, because the result produced is the statistically most likely. Other methods of pitch detection are assessing the zero crossing rate. This method reveals the periodicity since the fundamental frequency is periodic and cycles around an origin level. A pitch detector can identify the periodic components within a segment of speech through time analysis such as the autocorrelation and zero crossing method or through frequency analysis. Frequency analysis techniques such as Harmonic Product Spectrum or Multi-rate Filtering use the harmonic frequency components to determine the fundamental pitch frequency.

Using the pitch estimate 900, the pitch contour block 320 generates a pitch contour 810 (see FIG. 8) for both the voiced and unvoiced portions of the detected speech 710 of the voice signal 700, as those of skill in the art will appreciate. In one embodiment, the pitch contour block 320 generates the pitch contour 810 of the unvoiced portions of the voice signal 700 using interpolation, as is known in the art. The pitch contour 810 serves as a running pitch average for the voice signal 700.

At step 614, the vocoder 304 encodes the voice signal 700, including the pitch contour 810. The encoded voice signal is then sent by the transmitter 306 to a receiving unit 204.

Pitch Shifting at the Receiver

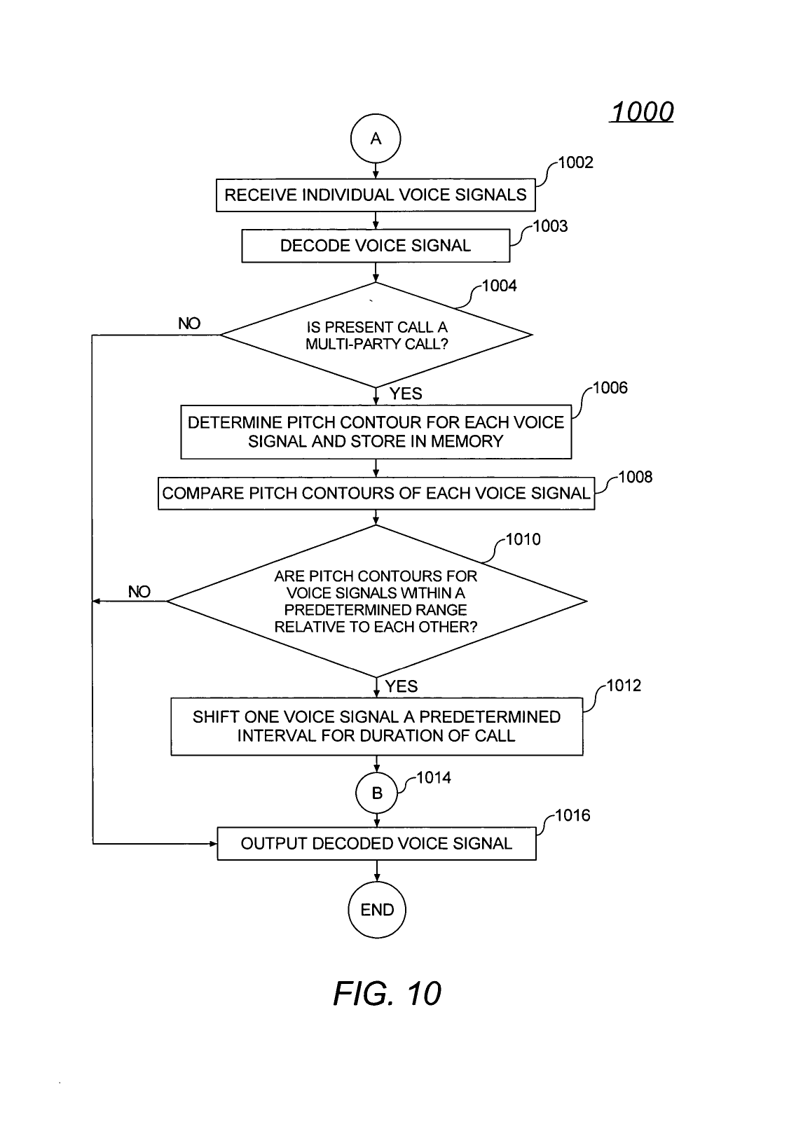

Referring to FIG. 10, illustrated is another portion of flow diagram of FIG. 6, illustrating portions of an exemplary pitch shifting process for improving speaker intelligibility in accordance with an embodiment of the present invention. The method continues at the receiving unit 204 where the receiving unit, at step 1002, receives individual voice signals and the vocoder 304, at step 1003, decodes the voice signals. Next, at step 1004, the receiving unit 204 determines if the present call is a multi-party call (i.e. that the receiving unit 204 is receiving signals from more than one transmitting unit during the present call). If the present call is not a multi-party call, then the call is processed as typically known in the art by outputting the decoded voice signal to a user, at step 1016, by way of a speaker or transducer 205.

If the receiving unit 204 determines that the present call is a multi-party call, then, at step 1006, the pitch contour information for each voice signal is determined from the data decoded by the vocoder 304 and stored in memory 210 for each party in the multi-party call. At step 1008, the pitch contour comparator 310 compares the pitch contour data to previous pitch contour data received from other parties during the present call. At decision block 1010, if the pitch contours are within a certain pre-determined range of each other, typically within one semitone, the pitch shifter 312 will shift the pitch of the voice signal, at step 1012, by a predetermined amount, either lower or higher, for the duration of the present call. Generally, the voice signal is shifted by one to approximately five semitones. The shifted voice signal is then output to the user, at step 1016, by way of a speaker or transducer 205, as known in the art. If, at decision block 1010, the pitch contours are separated by more than a predetermined amount, then the voice signal is unaltered before being output to the user at step 1016.

A slightly different method is used when the multi-party call is routed through a central control station 110. Because the central control station 110 combines the individual voice signals of a multi-party call before transmitting them to a receiving unit 204, it is necessary to perform the pitch shifting process directly at the control station 110 prior to summation, instead of at the receiving unit 204. Otherwise, the receiving unit 204 would be unable to distinguish the individual voices in the combined signal. In this manner, it is possible to perform the method on both wired and wireless devices involved in the multi-party call.

Central Control Office Pitch Sifting

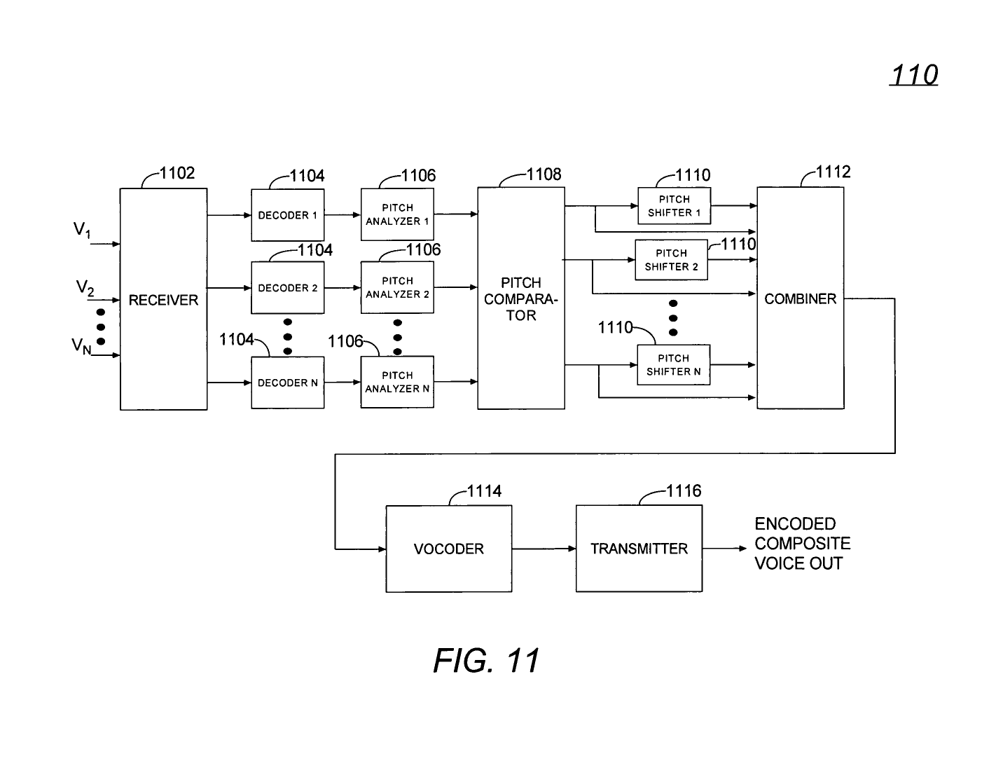

FIG. 11 is a more detailed block diagram illustrating a central control station of the system of FIG. 1, according to another embodiment of the present invention. Referring to FIGS. 10, 11 and 11, a receiver 1102 at the central control station 110 receives the individual voice signals from each transmitting unit 212 involved in the multi-party call, at step 1002, Note that it is possible for each transmitting unit 212 to use different vocoders or even analog processing; therefore the central control station 110 is equipped with decoders 1104 to decode each individual voice signal, at step 1003. If it is determined, at decision block 1004, that the present call is a multi-party call, pitch analyzers 1106 will determine a pitch contour for each voice signal, at step 1006 in a manner previously described in this invention. The resulting pitch contours are compared, at step 1008, by a pitch comparator 1108. If it is determined, at step 1010, that two or more voice signals are within a certain predetermined range of each other, then at least one voice signal will be shifted a predetermined amount (usually one to approximately five semitones), at step 1012. In this embodiment, the process block 1014 of FIG. 10 is illustrated in further detail in FIG. 11. Turning to FIG. 12, shown is an operational flow diagram illustrating portions of an exemplary pitch sifting process for improving speaker intelligibility at a central control station of FIG. 10 in accordance with another embodiment of the present invention. Beginning at step 1202 of FIG. 12, the individual voice signals are combined into one composite signal. This combined voice signal is encoded by a vocoder 1114 at step 1204. The encoded voice signal is then transmitted to a receiving unit 204, at step 1206, for processing in accordance with traditional means.

Non-Limiting Examples

The present invention can be realized in hardware, software, or a combination of hardware and software. An embodiment of the present invention can also be embedded in a computer program product, which comprises all the features enabling the implementation of the methods described herein, and which, when loaded in a computer system, is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer-readable medium, allowing a computer system, to read data, instructions, messages or message packets, and other computer-readable information from the computer-readable medium. The computer-readable medium may include non-volatile memory, such as ROM, Flash memory, Disk drive memory, CD-ROM, and other permanent storage. Additionally, a computer-readable medium may include, for example, volatile storage such as RAM, buffers, cache memory, and network circuits. Furthermore, the computer-readable medium may comprise computer-readable information in a transitory state medium such as a network link and/or a network interface, including a wired network or a wireless network, that allow a computer system to read such computer-readable information.

Computer programs (also called computer control logic) are stored in main memory 210 and/or secondary memory 211. Computer programs may also be received “over-the-air” via one or more wireless receivers. Such computer programs, when executed, enable the subscriber unit 102 to perform the features of the present invention as discussed herein. In particular, the computer programs, when executed, enable the processor 202 to perform the features of the wireless device 102. Accordingly, such computer programs represent controllers of the wireless device 102.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments.

Furthermore, it is intended that the appended claims cover any and all such applications, modifications, and embodiments within the scope of the present invention.

What is claimed is:

1. A method for improving speaker intelligibility in a multi-party call, the method comprising:
receiving a plurality of individual voice signals;
determining a pitch contour for at least two individual voice signals;
determining that the pitch contours for the at least two of the individual voice signals are within a predetermined range relative to each other; and
shifting the pitch of at least one voice signal of the two at least two individual voice signals, a predetermined amount for the duration of the call.

2. The method of claim 1, further comprising:
outputting the at least one pitch-shifted voice signal along with at least one of the plurality of individual voice signals which have not been pitch-sifted to a user.

3. The method of claim 1, further comprising:
combining the at least one pitch-shifted voice signal along with at least one of the plurality of individual voice signals which have not been pitch-shifted into a single composite voice signal;
encoding the single composite voice signal; and
transmitting the single composite voice signal to a receiving unit.

4. The method of claim 1, wherein the predetermined range of pitch contours relative to each other is one semitone.

5. The method of claim 1, wherein the predetermined amount to shift the pitch of at least one voice signal is one to 4 semitones.

6. A wireless device comprising:
a receiver for receiving a plurality of individual voice signals;
a vocoder, communicatively coupled to the receiver, for decoding the individual voice signals;
a pitch contour comparator, communicatively coupled to the vocoder, for determining that the pitch contours for at least two of the individual voice signals are within a predetermined range relative to each other; and
a pitch shifter, communicatively coupled to the pitch contour comparator, for shifting the pitch of at least one voice signal a predetermined amount.

7. A central control station comprising:
a receiver for receiving a plurality of individual voice signals;
at least one vocoder, communicatively coupled to the receiver, for decoding the individual voice signals;
at least one pitch analyzer, communicatively coupled to the vocoder, for determining a pitch contour for each individual voice signal;
a pitch contour comparator, communicatively coupled to the pitch analyzer, for determining that the pitch contours for at least two of the individual voice signals are within a predetermined range relative to each other; and
at least one pitch shifter, communicatively coupled to the pitch contour comparator, for shifting the pitch of at least one voice signal a predetermined amount; and
a signal combiner, communicatively coupled to the pitch shifter and the pitch contour comparator, for combining the at least one pitch-shifted voice signal and a remainder of the plurality of individual voice signals into a single composite voice signal.

8. The central control station of claim 6, further comprising:
a vocoder, communicatively coupled to the signal combiner, for encoding the single composite voice signal; and
a transmitter, communicatively coupled to the vocoder, for transmitting the single composite voice signal to a receiving unit.

9. A communication system comprising:
at least three wireless device for wireless communication, each wireless device comprising:
a transmitter for transmitting an individual voice signal;
a receiver for receiving a plurality of individual voice signals;
a vocoder, communicatively coupled to the receiver, for decoding the individual voice signals;
a pitch contour comparator, communicatively coupled to the vocoder, for determining that the pitch contours for at least two of the individual voice signals are within a predetermined range relative to each other; and
a pitch shifter, communicatively coupled to the pitch contour comparator, for shifting the pitch of at least one voice signal a predetermined amount.

10. A communication system comprising:
at least three communication devices; and
a central control station, the central-control station comprising:
a receiver for receiving a plurality of individual voice signals;
a plurality of vocoders, communicatively coupled to the receiver, for decoding the individual voice signals;
a plurality of pitch analyzers, communicatively coupled to the plurality of vocoders, for determining a pitch contour for each individual voice signal;
a pitch contour comparator, communicatively coupled to the plurality of pitch analyzers, for determining that the pitch contours for at least two of the individual voice signals are within a predetermined range relative to each other; and
a plurality of pitch shifters, communicatively coupled to the pitch contour comparator, for shifting the pitch of at least one voice signal a predetermined amount; and
a signal combiner, communicatively coupled to the plurality of pitch shifters and the pitch contour comparator, for combining the at least one pitch-shifted voice signal along with at least one of the plurality of individual voice signals which have not been pitch-shifted into a single composite voice signal.

11. The communication system of claim 10, wherein the central control station further comprises:
a vocoder, communicatively coupled to the signal combiner, for encoding the single composite voice signal; and
a transmitter, communicatively coupled to the vocoder, for transmitting the single composite voice signal to a receiving unit.

12. A computer readable medium comprising instructions for improving speaker intelligibility in a multi-party call, the instructions comprising:
receiving a plurality of individual voice signals;
determining a pitch contour for at least two individual voice signals;
determining that the pitch contours for the at least two of the individual voice signals are within a predetermined range relative to each other; and
shifting the pitch of at least one voice signal of the two at least two individual voice signals, a predetermined amount for the duration of the call.

13. The computer readable medium of claim 12, further comprising instructions for:
outputting the at least one pitch-shifted voice signal along with at least one of the plurality of individual voice signals which have not been pitch-sifted to a user.

14. The computer readable medium of claim 12, further comprising instructions for:
combining the at least one pitch-shifted voice signal and a remainder of the plurality of individual voice signals into a single composite voice signal;
encoding the single composite voice signal; and
transmitting the single composite voice signal to a receiving unit.

15. The computer readable medium of claim 12, wherein the predetermined range of pitch contours relative to each other is one semitone.

16. The computer readable medium of claim 12, wherein the predetermined amount to shift the pitch of at least one voice signal is one to 4 semitones.
